(19) United States
(12) Patent Application Publication
(10) Pub. No.: US 2006/0266778 A1
(43) Pub. Date: Nov. 30, 2006

(54) Collapsible tool/utility box

(76) Inventor: Nii-Akwei Allotey, Denver, CO (US)

Correspondence Address: MARIAN J. FURST, ATTORNEY AT LAW, 4956 W.6200 S., #315, KEARNS, UT, 84118, US

(21) Appl. No.: 11/137,887

(22) Filed: May 26, 2005

(51) Int. Cl. B60R 9/00

(52) U.S. Cl. 224/403; 224/497; 224/404

(57) ABSTRACT

Collapsible or foldable tool/utility box that can be folded into a compact configuration when not in use or unfolded to form a container for tools or other objects. The box is particularly suitable for use as a storage container mounted to a pickup truck bed.

### FIELD OF THE INVENTION

The present invention relates generally to tool or utility storage boxes, and more particularly to collapsible tool or utility storage boxes.

### BACKGROUND OF THE INVENTION

Often, it is desirable to carry items such as tools or packages in the back of a pickup truck or in the trunk of car. If the items are not secured or restrained in place, they can slide around while the vehicle is in motion, causing noise and possibly damaging the items and/or the vehicle. If smaller items are carried in the uncovered back of a pickup truck, it is also desirable that they are placed inside a lockable container, particularly if the items are valuable or subject to damage from wind and weather. Ideally, the container is itself anchored to the bed or sides of the cargo area, so the container cannot be easily removed, such as by a potential thief.

Tool boxes are available that can be installed in the beds of pickup trucks. In general, these boxes fit into the front portion of the pickup truck cargo area, in front of the rear wheel wells. The container dimensions must be customized for the particular model of truck, because different models have different widths and different lengths between the front of the truck bed and the front of the wheel wells. Usually, these tool boxes are permanently installed, with a resulting loss of space for other cargo.

However, it may be desirable to use the vehicle for other purposes where the space occupied by the container is needed. Thus, there is a need for a tool or utility storage box for transporting tools and/or other items in the back of a pickup truck or in the trunk of a car, that can be easily set up and collapsed, as needed. Further, there is a need for a tool/utility storage box that can easily be mounted in a variety of models of trucks and cars.

### SUMMARY OF THE INVENTION

It is an object of the present invention to provide a collapsible tool/utility storage box for vehicles that is easily set up for use and easily collapsed for compact storage when it is not needed.

It is a further object of the present invention to provide a collapsible tool/utility storage box that can be permanently mounted in a pickup truck bed.

It is yet another object of the present invention to provide a collapsible tool/utility storage box that is compact when collapsed.

To achieve the foregoing and other objects and in accordance with the purpose of the present invention broadly described herein, one embodiment of this invention comprises a collapsible storage box. The box comprises a rear portion, side walls, a bottom, and a cover. The substantially planar wall of the rear portion has a lower edge, side edges, and a top edge. The side walls have hinges joining said side portions to each other and to the side edges of the rear portion, and the side walls are foldable and unfoldable relative to each other and relative to the rear portion by rotation at the hinges. The bottom is disposed between the rear portion and the side walls, and it is attached to the rear portion adjacent the lower edge by a hinge mechanism such that the bottom is pivotable between a position substantially parallel to the rear portion and substantially perpendicular to the rear portion. The cover is pivotally joined to the rear portion adjacent the top edge of the rear portion and has a substantially planar section. The cover can pivot between a collapsed configuration with the planar section substantially parallel to the planar wall of the rear portion and an open configuration with the planar section forming an angle greater than about 90 degrees with the planar wall of the rear portion. The box is adjustable between a collapsed configuration with the bottom, the side walls, and the top pivoted into positions substantially parallel to the planar wall of the rear portion and an uncollapsed configuration with the bottom and the top substantially perpendicular to the planar wall of the rear portion and with the side walls substantially perpendicular to the bottom and the cover.

Additionally, the box may further comprise bracing means for stiffening the side walls when the box is in an uncollapsed configuration. The rear portion of the box may include side extensions projecting from the planar wall, and the side walls may be hingedly attached to the side extensions. The rear portion may include a top extension projecting from the top edge of the wall and a top flange projecting substantially upwards from the top extension, with the cover pivotally joined to the flange. The box may also include means for mounting the box to another object. The mounting means may comprise a mounting bracket and fasteners, and the bracket may be adapted for mounting to a side wall of a pickup truck bed and for mounting to the box by securing some of the fasteners through holes in the truck bed wall and others of the fasteners through holes in the box.

Preferably, the box has dimensions such that it fits within a bed of a pickup truck, and more preferably, it has dimensions such that it fits within a bed of a pickup truck and between the truck wheel wells. The box may form a rectangular prism shape when uncollapsed. Preferably, the box comprises means for locking it. Also preferably, the box is substantially dust- and water-tight. It may include means for maintaining a desired position of the top relative to the rear portion, such as a hydraulic mechanism attached to the rear portion and to the cover.

Another embodiment of the present invention comprises a mounting bracket for a collapsible tool/utility box. The bracket includes a first portion adapted for mounting to a wall of a pickup truck bed and a second portion adapted for mounting to a wall of the tool/utility box. The second portion includes slots within which fasteners are positionable such that the fasteners align with holes in the wall of the tool/utility box. The fasteners may be positionable with the bottom of the box resting on the floor of the truck bed. Alternatively, the mounting bracket may comprise means for supporting the box against the wall of the pickup truck bed with the bottom of the box raised above the floor of the truck bed.

### BRIEF DESCRIPTION OF THE DRAWINGS

These and other features, aspects, and advantages of the present invention will become better understood with reference to the following description, appended claims, and accompanying drawings, where:

FIG. 1 is an exploded perspective of a box in accordance with the present invention;

FIG. 2 is a perspective view of the box of FIG. 1 in a collapsed configuration;

FIG. 3 is a perspective view of the box of FIG. 1 in a partially uncollapsed configuration;

FIG. 4 is a perspective view of the box of FIG. 1 in a partially uncollapsed configuration;

FIG. 5 is a perspective view of the box of FIG. 1, uncollapsed and ready for storing objects;

FIG. 6 is a detailed view of a brace for the sides of the box of FIG. 1; and

FIG. 7 is an exploded perspective view of a system for mounting the box of FIG. 1 to the side of a truck bed.

### DESCRIPTION OF THE PREFERRED EMBODIMENT

The present invention comprises a collapsible box suitable for use as a tool box or utility container. The box may be free-standing or mounted in the back of a pickup truck or in the trunk or other cargo space of a car or other vehicle. Preferably, the collapsed box is relatively thin, perhaps about 2 inches thick. In the following description, references to orientation in space, such as horizontal, vertical, top, bottom, or sides are intended to describe the box in its normal configuration during use.

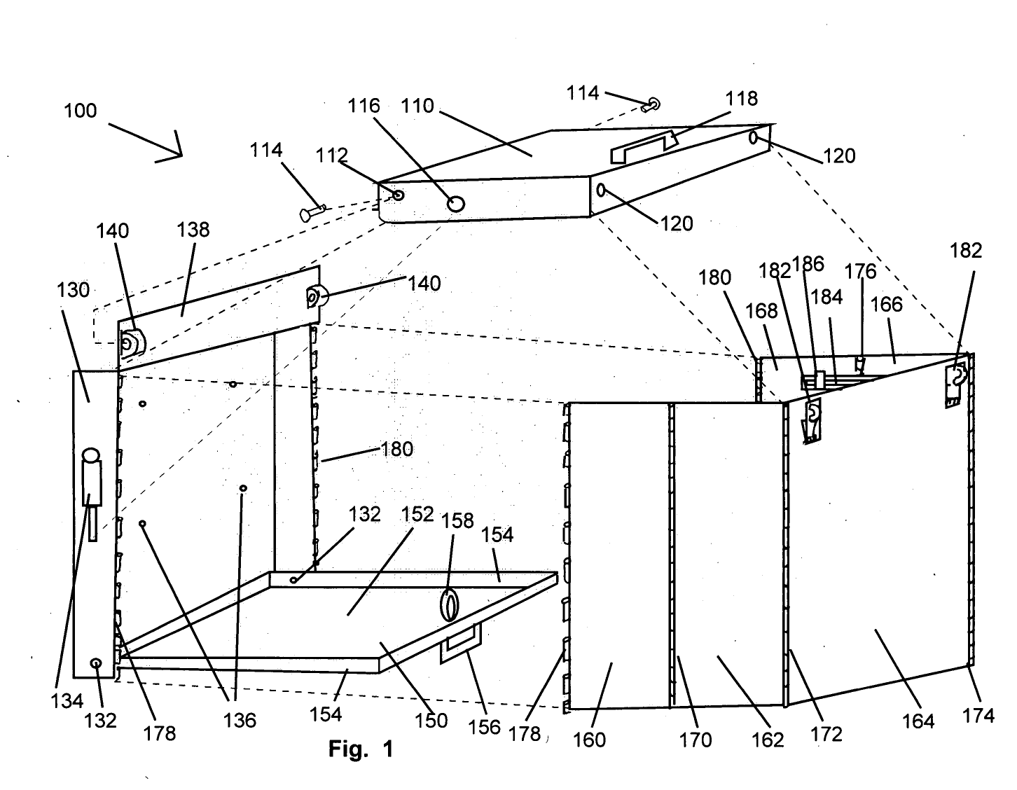

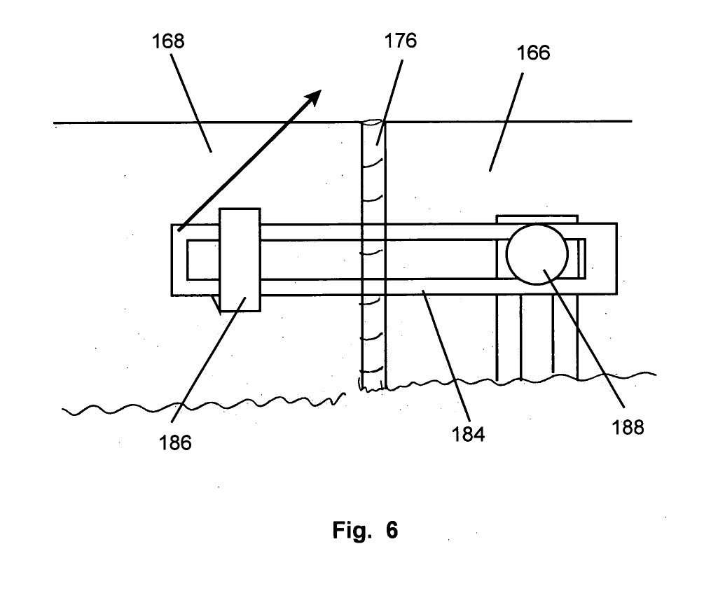

One embodiment of the present invention may be understood with reference to FIGS. 1-7. A collapsible or foldable box 100 includes a cover 110, a rear wall portion 130, a bottom 150, and hinged wall portions 160, 162, 164, 166, and 168, connected to each other with piano-type hinges 170, 172, 174, and 176. Piano-type hinges 178 and 180 connect wall portions 160 and 168, respectively, to rear wall portion 130.

Cover 110 includes a substantially flat section with side extensions projecting downward from the flat section. Holes 112 are sized to accommodate hinge pins 114. Connector 116 is positioned and adapted to receive one end of a positioning mechanism. Cover 110 is provided with a handle 118 and holes 120.

Rear wall portion 130 has a substantially planar section with side, top, and bottom extensions projecting toward the front of box 100. The vertical side extensions include parts of piano hinges 178 and 180 and holes to accommodate pivot pins 132. Hydraulic positioning mechanism 134 is engageable with connector 116 on cover 110. The planar section of rear wall portion 130 includes holes 136. Flange 138 projects upwardly from the cover side extension and includes hinge parts 140, which are positioned to align with holes 112 in cover 110 and to accommodate hinge pins 114.

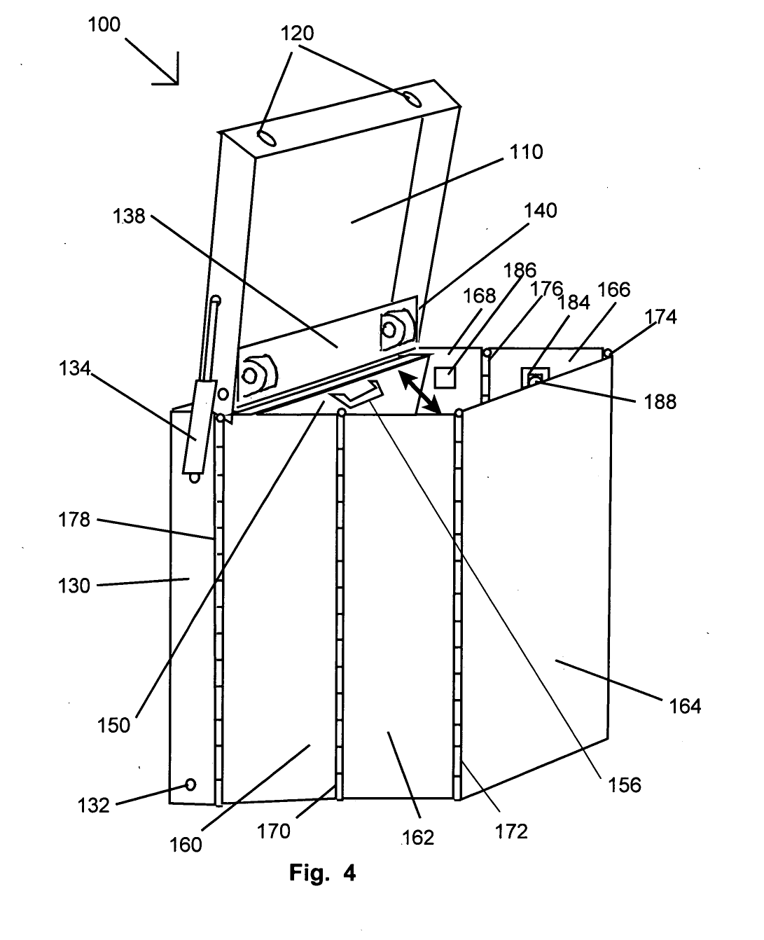

Bottom 150 is connected to rear wall portion 130 via a hinge mechanism that includes hinge pins 132. Bottom 150 includes a substantially planar section 152 and upwardly projecting side extensions 154. The seams between planar section 152 and the side extensions 154 are preferably formed in a manner that is water-tight, or, alternatively, a water-tight seal may be applied to the seams. Bottom 150 is pivotable about hinge pins 132, and it remains between the walls 160, 162, 164, 166, and 168 and rear portion 130. The arrow in FIG. 4 indicates the motion of the bottom 150 as it pivots. Handles 156 and 158 are positioned near the edge of bottom 150 that is farthest from the attachment to wall portion 130 and aid in positioning bottom 150. Any type of handle known in the art could be used. However, rigid handle 156 can function also as a support for bottom 150 when the box is in the unfolded or uncollapsed configuration. Handle 158 can comprise a flexible material, such as cord or webbing. Bottom 150 may include resilient pads for shock absorption and to prevent the box from rattling while the vehicle in which it is carried moves.

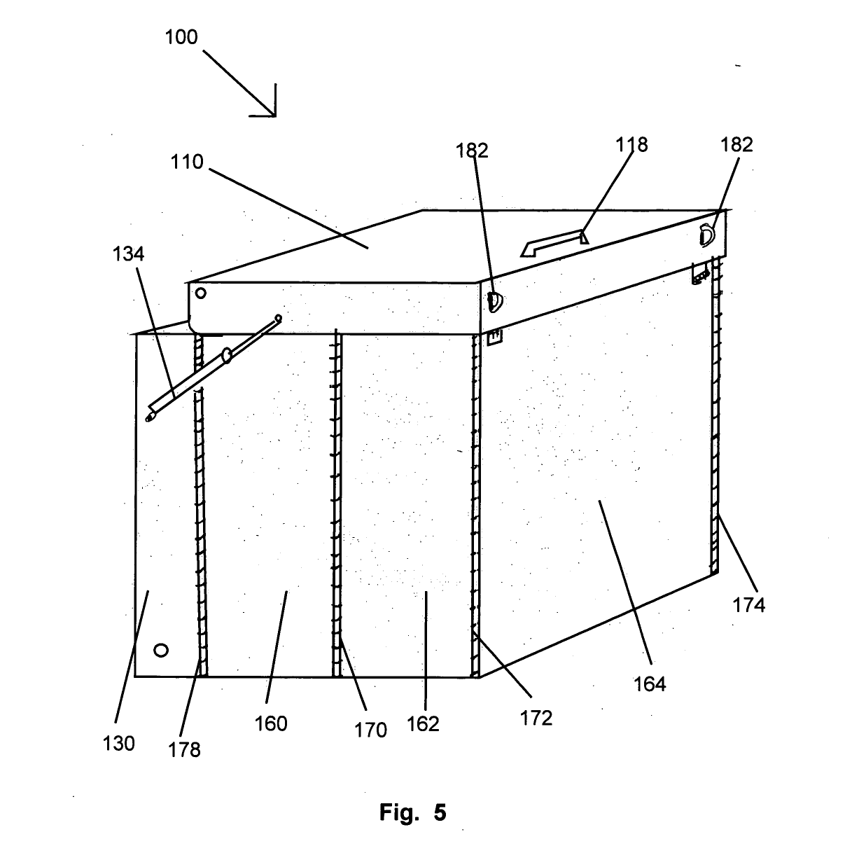

Once the box 100 is unfolded, it may then be closed, as shown in FIG. 5, by lowering cover 110. Wall portion 164 is provided with hasps 182, which are positioned to align with and extend through holes 120. Padlocks or a cable looped through hasps 182, not shown, may be used to lock cover 110 onto the rest of the box to provide security and protection for any articles inside the box. Preferably, the wall portions 160 and 162 and the wall portions 166 and 168 are provided with braces, such as a pivotable bar 184 and a bracket 186, to help stiffen the hinged sides when the box is in use as a container for tools or other objects.

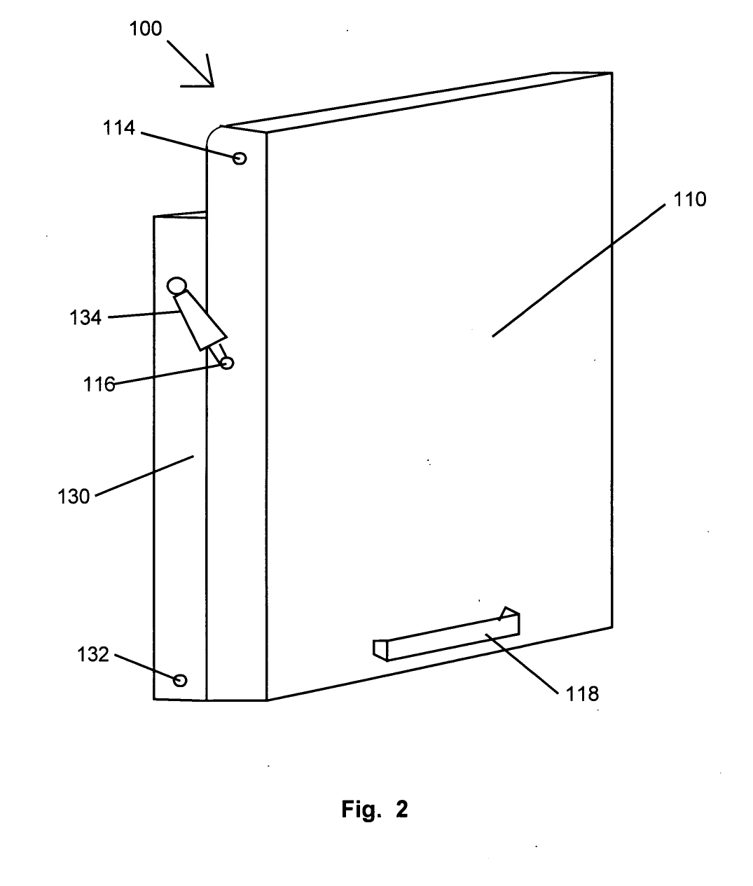

As shown in FIG. 2, box 100 is in a collapsed or folded configuration, with cover 110 positioned adjacent rear wall portion 130. Cover 110 is connected to upwardly projecting flange 138, not visible in FIG. 2, via hinge mechanism 140 with hinge pins 114 and by hydraulic positioning mechanism 134. Hydraulic mechanism 134 functions to maintain the position of cover 110 relative to rear wall portion 130, particularly when box 100 is in a collapsed or folded configuration. Handle 118 is mounted onto cover 110 adjacent the edge farthest away from the hinge mechanisms 140 and hinge pins 114.

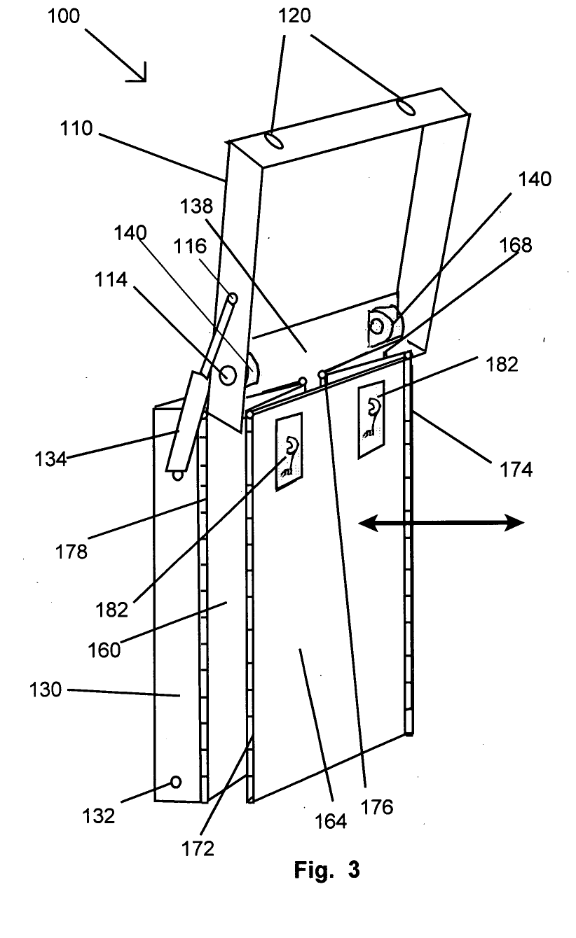

To unfold box 100, cover 110 is pivoted upwards to expose walls 160, 162, 164, 166, and 168, collapsed along hinges 170, 172 174, 176, 178, and 180. The wall sections can be unfolded to form a rectangular enclosure. The walls are slightly unfolded as shown in FIG. 3, with the arrow indicating the direction of motion of wall 164 as the box is unfolded and collapsed. The walls are completely unfolded in FIG. 4.

With the box 100 collapsed, box bottom 150 is positioned in a vertical position adjacent the vertical planar section and within the side projections of rear wall portion 130. Referring to FIG. 4, box bottom can be rotated about pivot pins 132 into a horizontal position contained within rear wall portion 120 and walls 160, 162, 164, 166, and 168. The arrow indicates the movement of the box bottom 150.

It is desirable to include one or more braces to prevent the walls of the box from collapsing or moving during use. One possible type of brace is shown in FIGS. 1, 4, and 6. A bar 184 on one short side wall can be engaged with a bracket 186 on an adjacent side wall. Bar 184 includes a slot and is slidable and pivotable on a pin 188 so that bar 184 can be moved out of the way when the box is collapsed.

Box 100 may be locked using a suitable locking mechanism. As shown, hasps 182 are provided, and padlocks or a locking cable can be passed through the eyes of the hasps. However, any suitable locking mechanism known in the art could be used, including but not limited to one or more locks mounted directly onto the box.

A box in accordance with the present invention can have dimensions suitable for storing any type of cargo, and the dimensions need not be limited to match the dimensions of any model pickup truck or other vehicle into which it is mounted. Indeed, the box may be sized to fit between the wheel wells of most truck models or along the side of a truck bed adjacent one wheel well for easy access. Alternatively, the box could be carried inside a vehicle or in a vehicle trunk. Although the box may be free-standing, it may be desirable to mount the box to the vehicle so the box cannot move around while the vehicle is in use and to prevent theft of the box.

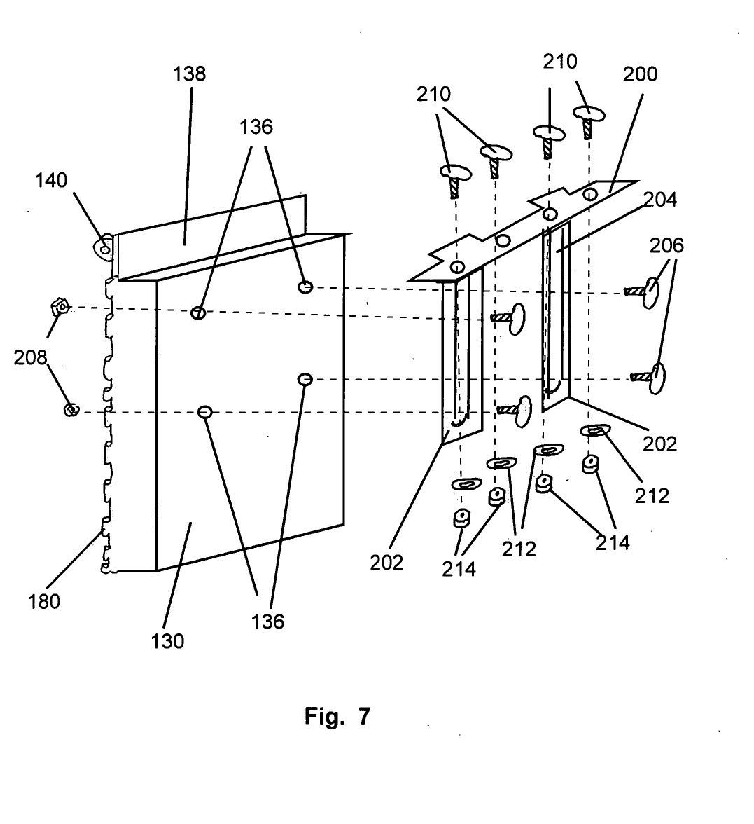

One suitable mounting system for securing box 100 in a vehicle, such as in the bed of a pickup truck, is shown in FIG. 7. Mounting bracket 200 includes extensions 202 with slots 204. Suitable fasteners, such as bolts 206, can pass through slots 204 and holes 136 in the rear wall portion of box 100 and are secured with nuts 208. Bracket 200 can be secured to the side of a pickup truck bed with bolts 210, washers 212, and nuts 214, or with any other suitable type of fastener known in the art. Mounting bracket 200 can be used with a wide variety of truck models. Bolts 206 may be positioned vertically within slots 204 so that they line up with holes 136 when box 100 rests on the floor of the truck bed. Alternatively, a mounting bracket may include a support for the bottom of the box that raises the box above the floor of the truck bed. However, it may be desirable to remove the box, such as when the truck is needed to carry large cargo. If appropriate fasteners, such as bolts with wing nuts, are used, the open box can be easily detachable from mounting bracket 200. Preferably, the fasteners are inaccessible when box 100 is closed and locked to provide security from theft of the box or its contents.

It is preferable that a tool/utility box, such as box 100, is sealed from dust, water, snow, and ice to protect the contents of the box. Thus, the side projections of cover 110 and bottom 150 may be attached to the planar portions of cover 110 and bottom 150 in a manner that provides seals. Hinges 170, 172, 174, 176, 178, and 180 may be covered with a sealing material, such as a strip of water-proof plastic or rubber or another similar flexible material.

The box in accordance with the present invention can be formed from any material or materials with suitable stiffness and durability to function as intended. For example, the cover, sides, and walls of the box could be formed from sheet metal, or they could be formed from plastic, such as by injection molding. Any type of hinge or hinges could be used between the sections, as long as the box is easily foldable and unfoldable, and preferably as long as the box can be made water- and dust-tight.

It should be noted that, depending upon the desired dimensions of the box, there could be additional hinged wall sections. Also, the walls, cover, and bottom could form a shape other than a rectangular prism.

The foregoing description is considered as illustrative only of the principles of the invention. Further, since numerous modifications and changes will readily occur to those skilled in the art, it is not desired to limit the invention to the exact construction and process shown and described above. Accordingly, all suitable modifications and equivalents may be resorted to falling within the scope of the invention.

I claim:

1. A collapsible storage box comprising:
a rear portion having a substantially planar wall and a lower edge, side edges, and a top edge;
side walls with hinges joining said side portions to each other and to said side edges of said rear portion, said side walls being foldable and unfoldable relative to each other and relative to said rear portion by rotation at said hinges;
a bottom disposed between said rear portion and said side walls and attached to said rear portion adjacent said lower edge by a hinge mechanism, said bottom pivotable between a position substantially parallel to said rear portion and substantially perpendicular to said rear portion, said bottom; and
a cover pivotally joined to said rear portion adjacent said top edge of said rear portion and having a substantially planar section, said cover pivotal between a collapsed configuration with said planar section substantially parallel to said planar wall of said rear portion and an open configuration with said planar section forming an angle greater than about 90 degrees with said planar wall of said rear portion;
wherein said box is adjustable between a collapsed configuration with said bottom, said side walls, and said top pivoted into positions substantially parallel to said planar wall of said rear portion and an uncollapsed configuration with said bottom and said top substantially perpendicular to said planar wall of said rear portion and with said side walls substantially perpendicular to said bottom and said cover.

2. The box of claim 1, further comprising bracing means for stiffening said side walls when said box is in an uncollapsed configuration.

3. The box of claim 1, wherein said rear portion includes side extensions projecting from said planar wall, and said side walls are hingedly attached to said side extensions.

4. The box of claim 1, wherein said rear portion includes a top extension projecting from said top edge of said wall and a top flange projecting substantially upwards from said top extension, and said cover is pivotally joined to said flange.

5. The box of claim 1, further comprising means for mounting said box to another object.

6. The box of claim 5, wherein said mounting means comprises a mounting bracket and fasteners.

7. The box of claim 6, wherein said bracket is adapted for mounting to a side wall of a pickup truck bed and for mounting to said box by securing some of said fasteners through holes in the truck bed wall and others of said fasteners through holes in said box.

8. The box of claim 1, having dimensions such that said box fits within a bed of a pickup truck.

9. The box of claim 1, having dimensions such that said box fits within a bed of a pickup truck and between the truck wheel wells.

10. The box of claim 1, further comprising means for locking said box.

11. The box of claim 1, wherein said box is substantially dust- and water-tight.

12. The box of claim 1, further comprising means for maintaining a desired position of said top relative to said rear portion.

13. The box of claim 12, wherein said means for maintaining comprises a hydraulic mechanism attached to said rear portion and to said cover.

14. The box of claim 1, wherein said box forms a rectangular prism shape when uncollapsed.

15. A mounting bracket for a collapsible tool/utility box, said bracket comprising:
a first portion adapted for mounting to a wall of a pickup truck bed; and
a second portion adapted for mounting to a wall of said tool/utility box, said second portion including slots within which fasteners are positionable such that the fasteners align with holes in said wall of said tool/utility box.

16. The mounting bracket of claim 15, wherein said fasteners are positionable with the bottom of the box resting on the floor of the truck bed.

17. The mounting bracket of claim 15, further comprises means for supporting the box against the wall of the pickup truck bed with the bottom of the box raised above the floor of the truck bed.
